(19) United States
(12) Patent Application Publication
(10) Pub. No.: US 2006/0259347 A1
(43) Pub. Date: Nov. 16, 2006

(54) Automatic gathering of customer satisfaction information

(76) Inventor: Zentaro Ohashi, Tokyo (JP)

Correspondence Address: COURTNEY STANIFORD & GREGORY LLP, P.O. BOX 9686, SAN JOSE, CA, 95157, US

(21) Appl. No.: 11/128,608

(22) Filed: May 13, 2005

(51) Int. Cl. G06F 17/30

(52) U.S. Cl. 705/10

(57) ABSTRACT

Automatic customer feedback gathering systems and methods are described that provide a switch array in one or more areas of a service provider outlet by which a customer indicates a level of satisfaction with his/her service. The switch array may include two or more touch-sensitive areas that each correspond to different levels of customer satisfaction. The switch array automatically generates a signal in response to a customer input, and the signal includes information of the level of the customer's satisfaction. The signal is transferred to a processor and a database. A service provider can generate reports using information of the received signal, where the reports may include cumulative customer satisfaction ratings for a time period and may associate the customer satisfaction information with other data of the service provider.

### TECHNICAL FIELD

The disclosure herein relates generally to gathering customer feedback information. In particular, this disclosure relates to systems and methods that allow service providers to electronically receive customer feedback information from customers.

### BACKGROUND

Service providers have long struggled with how to gather accurate customer satisfaction or feedback information without inconveniencing their customers. Many service providers have used survey cards or forms in an attempt to gather information from their customers. The cards or forms often can be found in a central location in an establishment like a retail store, museum, or hotel lobby, and/or in numerous locations around an establishment like the tables in a restaurant or each room of a hotel. While the cards can provide detailed information of the customer's experience to the merchant, they are often ignored by customers because of the length of time required to read and complete the information of the form. Further, when the paper surveys are completed by customers they do not provide the feedback information in any form useful for assimilation, report generating, or long-term use by the merchant. Thus, the merchant is required to enter the data of the form in an electronic database if he/she wishes to assemble any statistical database relating to customer service provided in his/her establishment.

### BRIEF DESCRIPTION OF THE DRAWINGS

FIG. 1 is a block diagram of an electronic Customer Feedback Gathering System (“CFGS”), under an embodiment.

FIG. 2 is a flow diagram for automatic gathering of customer feedback or satisfaction information, under an embodiment.

FIG. 3 is a computer system hosting one or more components of the CFGS, under an embodiment.

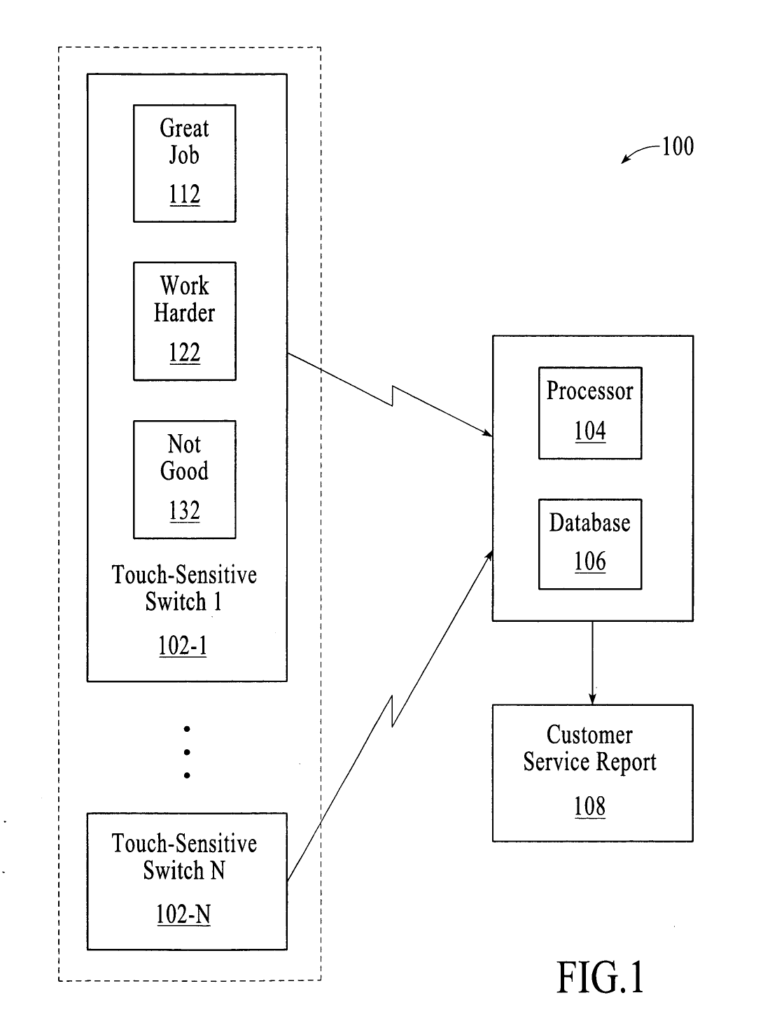

In the drawings, the same reference numbers identify identical or substantially similar elements or acts. To easily identify the discussion of any particular element or act, the most significant digit or digits in a reference number refer to the Figure number in which that element is first introduced (e.g., element 102 is first introduced and discussed with respect to FIG. 1).

### DETAILED DESCRIPTION

Automatic customer feedback gathering systems and methods are described that provide a switch array by which a customer can readily indicate a level of satisfaction with his/her service. These systems and methods, collectively referred to herein as “Customer Feedback Gathering Systems (“CFGS”)”, include a switch array placed in one or more areas of a service provider outlet by which customers indicate via touching their level of satisfaction with the received service. The switch array may include two or more touch-sensitive areas that each correspond to different levels of customer satisfaction. The switch array automatically generates a signal in response to a customer input, and the signal includes information of the customer's satisfaction level. The signal is automatically transferred to a processor and a database. A service provider can generate reports using information of the received signal, where the reports may include customer satisfaction ratings (e.g., cumulative ratings) for a period of time and may associate the customer satisfaction information with other data of the service provider.

The service providers using the CFGS may include any type of providers needing feedback information from their customers, including but not limited to retail shops, restaurants, hotels, theaters, museums, trade shows, sports arenas, and offices to name a few. The feedback switches of the switch array may be located in conspicuous locations of the service provider facility so as to be convenient to a customer in registering his/her satisfaction level with the received service. The feedback switches may be located, for example, adjacent to a cashier station or an exit point of the service provider so that customers can easily register their satisfaction or dissatisfaction with the provider simply by touching an appropriate area of the switches. The CFGS therefore provides a simple and effective means by which customers can register feedback with a service provider without the need for filing out cumbersome surveys. In this manner the service providers are more likely to receive the feedback they desire because the CFGS provides an efficient and quick means by which customers should be more willing to provide feedback.

In the following description, numerous specific details are introduced to provide a thorough understanding of, and enabling description for, embodiments of the CFGS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

FIG. 1 is a block diagram of an electronic Customer Feedback Gathering System (“CFGS”) 100, under an embodiment. The CFGS 100 includes a switch array 102 coupled to a processor 104 and database 106. The switch array 102 is located in a service provider facility in one or more areas that are readily accessible to customers. The switch array 102 is configured to automatically generate and transmit signals in response to customer inputs, the signals including customer satisfaction information.

A communication system (not shown) transfers signals from the switch array 102 to the processor 104. The communication system may include any of a number of communication system components and protocols. For example, the communication system may include at least one of transmitters, receivers, and transceivers as appropriate to communication protocols used by the switch array 102 and the processor 104. The communication system transfers information between the switch array 102, processor 104, and/or other components of the CFGS using at least one of wireless, wired, or hybrid wireless/wired communications. The communication system may additionally or alternatively include one or more of wired and wireless networks and corresponding network components, where the networks can be any of a number of network types known in the art including, but not limited to, local area networks (LANs), metropolitan area networks (MANs), wide area networks (WANs), and proprietary networks to name a few.

The signals communicated from the switch array 102 include information of the customer as appropriate to the information allowed to be entered via touch-sensitive areas or switches of the switch array 102. For example, the signal may include information of a whether a customer considered his/her experience at the service provider facility a “GOOD” or “BAD” experience as described below. Additionally, the switch array 102 may be configured to include an input device or area that allows customers to enter and/or select appropriate customer personal information, the personal information including at least one of name, age, gender, and address. Transmission of the signals may be initiated by the switch array 102 in response to customer entry of the information or, alternatively, the processor may pull the information from the switch array 102 at periodic intervals.

The processor 104, upon receipt of the signals from the switch array 102, stores the customer satisfaction information of the signals in the database 106. The processor 104 can generate customer service reports using information of the database 106, for example, but may generate other types of reports as appropriate to the service provider. The database may store or include other information appropriate to the service provider, where examples of additional information include at least one of information of employees, dates of the customer inputs, and times of the customer inputs for example. The processor 104 generates the report manually or automatically to include cumulative customer satisfaction information for a pre-specified period of time. When configured appropriately, the processor may generate reports that correlate the customer satisfaction information with at least one of employees on duty at a time of the customer input, dates of the customer inputs, times of the customer inputs, as well as any other information of the database.

The switch array 102 may include any number of switches in any number of locations throughout a service provider's facility. For example, the switch array 102 may include a single switch in a central location of the service provider facility like a check-out station or a customer service station. This single switch may include a first touch-sensitive area by which a customer indicates a first level of customer satisfaction and a second touch-sensitive area by which the customer indicates a second level of customer satisfaction.

Alternatively, the switch array 102 may include two or more switches each of which are located in different locations of the service provider facility. Again, each switch includes some number of touch-sensitive areas by which a customer indicates a respective one of a plurality of levels of customer satisfaction.

The switch array 102 generally includes some number “N” of switches, where N can be 1, 2, . . . X. Each switch 102-1/102-N of the switch array 102 includes some number of touch-sensitive areas 112/122/132 that each correspond to a level of customer satisfaction. As an example, a first area 112 of the switch 102-1 indicates the customer feels the service provider did a “GREAT JOB”, a second area 122 of the switch 102-1 indicates the customer feels the service provider should “WORK HARDER”, and a third area 132 of the switch 102-1 indicates the customer feels the service provider's performance was “NOT GOOD”.

The number of touch-sensitive areas of each switch 102-1 to 102-N is as appropriate to the service provider and the customer satisfaction information to be gathered. For example, a switch may include five (5) different touch-sensitive areas each corresponding to a numerical service rating of one (“1”), two (“2”), three (“3”), four (“4”), and five (“5”). Each touch-sensitive area of the switch 102-1 to 102-N may include markings, labels, or icons as appropriate to the customer satisfaction information to be gathered.

Further, all switches 102-1 to 102-N of a switch array 102 are not required to be configured to provide the same information. For example, a service provider facility may include a retail shopping area and a restaurant area, and the merchant may want to use a different customer satisfaction rating system in each different area. Thus, in this example, the merchant may place a first type of switch in one or more regions of the shopping area and a second type of switch in one or more regions of the restaurant area. Numerous different types of switches may be used as appropriate to different types and/or areas of service provider facilities.

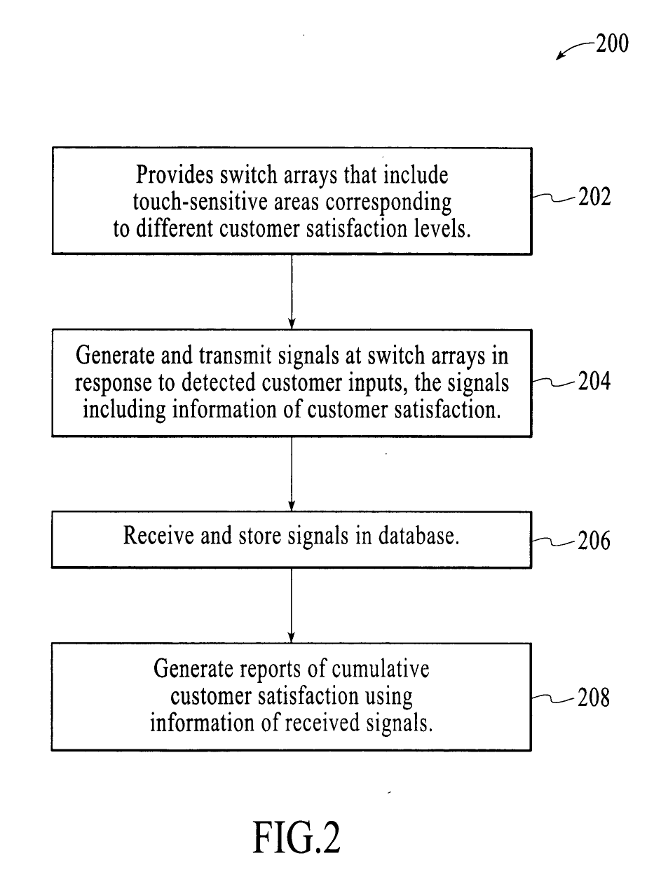

FIG. 2 is a flow diagram for automatic gathering of customer feedback or satisfaction information 200, under an embodiment. The gathering of customer feedback information provides 202 a switch array in one or more areas of a service provider outlet by which a customer indicates a level of satisfaction with his/her service. The switch array may include two or more touch-sensitive areas that each correspond to different levels of customer satisfaction. The switch array automatically generates 204 a signal in response to a detected customer input. The signal includes information of the customer's satisfaction level. The signal is transferred from the switch array, and received 206 at a processor where the information is stored in a database. A service provider can generate 208 reports using the feedback information received from the switch array. The reports may include cumulative customer satisfaction ratings for a time period and may associate the customer satisfaction information with other data of the service provider.

Referring to FIGS. 1 and 2, the operations of the CFGS are under control of at least one processor, but are not so limited. Those skilled in the relevant art can create source code, microcode, program logic arrays or otherwise implement the CFGS based on these flow diagrams and the detailed description provided herein. The algorithm or routine operating according to these flow diagrams is stored in non-volatile memory that forms part of the associated processors, in the associated memory areas, in removable media, such as disks, or hardwired or preprogrammed in chips, such as electronically erasable programmable ROM (“EEPROM”) semiconductor chips, or in any combination of these components, but is not so limited.

Aspects of the CFGS, described above, are described in terms of processes executed on one or more types of processing system. These processes are implemented as program code stored in machine-readable or computer-readable memory areas or devices of a computer system and are executed by the processor of the computer system.

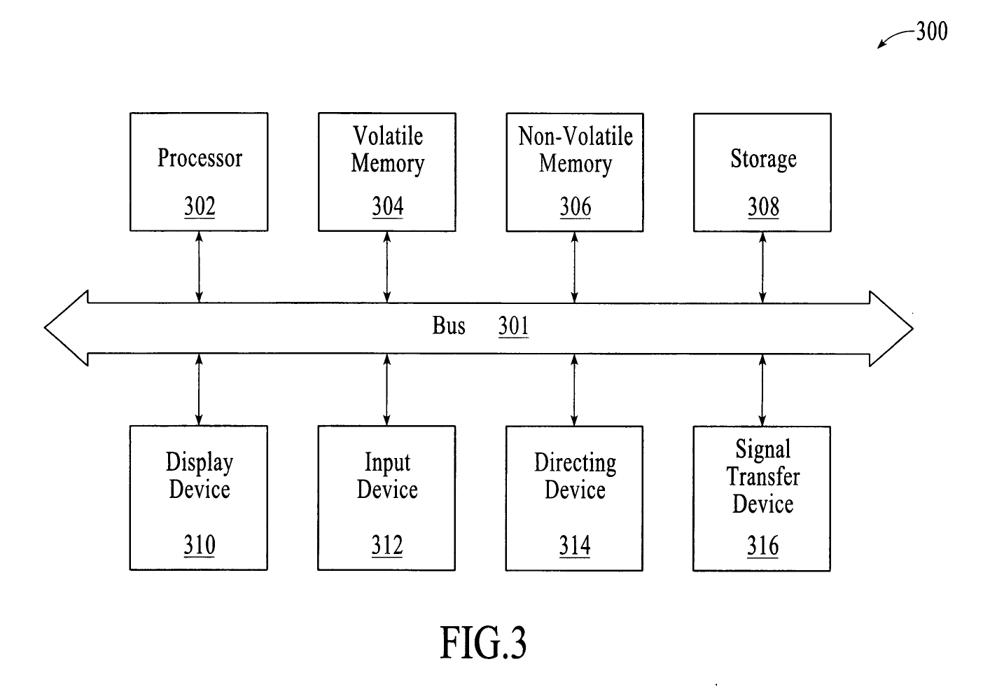

Although a variety of different computer systems can be used with the CFGS system, FIG. 3 is a computer system 300 hosting one or more components of the CFGS, under an embodiment. The computer system 300 generally includes a central processor unit (“CPU”) or central processor 302 for processing information and instructions, an address/data bus 301 coupled to the CPU 302 for communicating information, volatile memory 304 (random access memory (“RAM”) for example) coupled to the bus 301 for storing information and instructions for the CPU 302, and non-volatile memory 306 (read-only memory (“ROM”) for example) coupled to the bus 301 for storing static information and instructions for the CPU 302. The computer system 300 may also include one or more optional storage devices 308 coupled to the bus 301 for storing information and instructions. The storage devices or data storage devices 308 can include one or more removable magnetic or optical storage media which are computer-readable memories. Some combination of the volatile memory 304, non-volatile memory 306, and/or storage device 308 include or store data structures describing components or processes of the CFGS described above, but the CFGS is not limited to storage in these devices.

The computer system 300 may also include at least one optional display device 310 coupled to the bus 301 for displaying information to the users of the computer system 300. The computer system 300 of an embodiment may also include one or more optional input devices 312 coupled to the bus 301 for communicating information and command selections to the CPU 302. Additionally, the computer system 300 may include an optional cursor control or directing device 314 coupled to the bus 301 for communicating user input information and command selections to the CPU 302. The computer system 300 may also include one or more optional signal transfer devices 316 (transmitter, receiver, modem, antenna, etc. for example) coupled to the bus 301 for interfacing with other computer systems.

The Customer Feedback Gathering System (“CFGS”) of an embodiment includes a system comprising at least one of a switch array that includes two or more touch-sensitive areas that each correspond to a level of customer satisfaction, the switch array located in a service provider facility, wherein the switch array is configured to automatically generate and transmit signals in response to customer inputs, the signals including customer satisfaction information, and a processor coupled to the switch array and to a database, the processor receiving the signals from the switch array and storing the customer satisfaction information in the database, the processor generating periodic reports using the customer satisfaction information of the database, the reports including cumulative customer satisfaction information for a time period.

The switch array of an embodiment includes a first switch in a first location of the service provider facility, wherein the first switch includes a first touch-sensitive area by which a customer indicates a first level of customer satisfaction and a second touch-sensitive area by which the customer indicates a second level of customer satisfaction.

The switch array of an embodiment includes two or more switches each of which are located in different locations of the service provider facility, wherein each switch includes a plurality of touch-sensitive areas by which a customer indicates a respective one of a plurality of levels of customer satisfaction.

The system of an embodiment further comprises a communication system coupled to the switch array and the processor, the communication system transferring the signals using at least one of wired, wireless, and hybrid wired/wireless communication protocols.

The database of an embodiment stores at least one of information of employees, dates of the customer inputs, and times of the customer inputs.

The reports of an embodiment correlate the customer satisfaction information with at least one of employees on duty at a time of the customer input, dates of the customer inputs, and times of the customer inputs.

The signals of an embodiment comprise customer personal information, the personal information including at least one of name, age, gender, and address.

The CFGS of an embodiment includes a method comprising at least one of providing a switch array in a service provider outlet, wherein the switch array includes two or more touch-sensitive areas that each correspond to a level of customer satisfaction, generating and transmitting a signal at the switch array in response to a customer input, the signal including information of the level of customer satisfaction, receiving the signal and storing the signal in a database, and generating a report using information of the received signal, the report including cumulative customer satisfaction ratings for a time period.

The switch array of an embodiment is provided to include a first switch in a first location of the service provider outlet, wherein the first switch includes a first touch-sensitive area by which a customer indicates a first level of customer satisfaction and a second touch-sensitive area by which the customer indicates a second level of customer satisfaction.

The switch array of an embodiment is provided to include two or more switches each of which are located in different locations of the service provider outlet, wherein each switch includes a plurality of touch-sensitive areas by which a customer indicates a respective one of a plurality of levels of customer satisfaction.

The transmitting and the receiving of an embodiment include transferring the signal using at least one of wired, wireless, and hybrid wired/wireless communication systems.

The database of an embodiment further includes at least one of information of employees, dates of the customer inputs, and times of the customer inputs.

The report of an embodiment correlates the customer satisfaction ratings with at least one of employees on duty at a time of the customer input, dates of the customer inputs, and times of the customer inputs.

The signal of an embodiment comprises customer personal information, the personal information including at least one of name, age, gender, and address.

The CFGS of an embodiment includes an apparatus comprising at least one of means for receiving in a service provider outlet electronic input information of a level of customer satisfaction, means for generating and transmitting a signal in response to the input information, the signal including information of the level of customer satisfaction, means for receiving the signal and storing the signal, and means for generating a report using information of the received signal, the report including cumulative customer satisfaction ratings for a time period.

The means of an embodiment for receiving electronic input information comprises a switch array that includes a first switch in a first location of the service provider outlet, wherein the first switch includes a first touch-sensitive area by which a customer indicates a first level of customer satisfaction and a second touch-sensitive area by which the customer indicates a second level of customer satisfaction.

The means of an embodiment for receiving electronic input information comprises a switch array that includes two or more switches each of which are located in different locations of the service provider outlet, wherein each switch includes a plurality of touch-sensitive areas by which a customer indicates a respective one of a plurality of levels of customer satisfaction.

The means of an embodiment for transmitting and the means for receiving the signal include at least one of wired, wireless, and hybrid wired/wireless communication systems.

The means of an embodiment for storing further includes at least one of information of employees, dates of the customer inputs, and times of the customer inputs.

The means of an embodiment for generating a report further comprises means for correlating the customer satisfaction ratings with at least one of employees on duty at a time of the customer input, dates of the customer inputs, and times of the customer inputs.

Aspects of the CFGS described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits (“ASICs”). Some other possibilities for implementing aspects of the CFGS include: microcontrollers with memory (such as electronically erasable programmable read only memory (“EEPROM”)), embedded microprocessors, firmware, software, etc. Furthermore, aspects of the CFGS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

It should be noted that components of the various CFGS systems and methods disclosed herein may be described using computer aided design tools and expressed (or represented), as data and/or instructions embodied in various computer-readable media. Computer-readable media in which components of the CFGS may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the CFGS is not intended to be exhaustive or to limit the CFGS to the precise forms disclosed. While specific embodiments of, and examples for, the CFGS are described herein for illustrative purposes, various equivalent modifications are possible within the scope of the CFGS, as those skilled in the relevant art will recognize. The teachings of the CFGS provided herein can be applied to other processing systems and methods, not only for the CFGS described above.

The elements and acts of the various embodiments described above can be combined to provide further embodiments. These and other changes can be made to the CFGS in light of the above detailed description.

In general, in the following claims, the terms used should not be construed to limit the CFGS to the specific embodiments disclosed in the specification and the claims, but should be construed to include all systems and methods that operate under the claims. Accordingly, the CFGS is not limited by the disclosure, but instead the scope of the CFGS is to be determined entirely by the claims.

While certain aspects of the CFGS are presented below in certain claim forms, the inventor contemplates the various aspects of the CFGS in any number of claim forms. Accordingly, the inventor reserves the right to add additional claims after filing the application to pursue such additional claim forms for other aspects of the CFGS.

What is claimed is:

1. A system comprising:
a switch array that includes two or more touch-sensitive areas that each correspond to a level of customer satisfaction, the switch array located in a service provider facility, wherein the switch array is configured to automatically generate and transmit signals in response to customer inputs, the signals including customer satisfaction information; and
a processor coupled to the switch array and to a database, the processor receiving the signals from the switch array and storing the customer satisfaction information in the database, the processor generating periodic reports using the customer satisfaction information of the database, the reports including cumulative customer satisfaction information for a time period.

2. The system of claim 1, wherein the switch array includes a first switch in a first location of the service provider facility, wherein the first switch includes a first touch-sensitive area by which a customer indicates a first level of customer satisfaction and a second touch-sensitive area by which the customer indicates a second level of customer satisfaction.

3. The system of claim 1, wherein the switch array includes two or more switches each of which are located in different locations of the service provider facility, wherein each switch includes a plurality of touch-sensitive areas by which a customer indicates a respective one of a plurality of levels of customer satisfaction.

4. The system of claim 1, further comprising a communication system coupled to the switch array and the processor, the communication system transferring the signals using at least one of wired, wireless, and hybrid wired/wireless communication protocols.

5. The system of claim 1, wherein the database stores at least one of information of employees, dates of the customer inputs, and times of the customer inputs.

6. The system of claim 1, wherein the reports correlate the customer satisfaction information with at least one of employees on duty at a time of the customer input, dates of the customer inputs, and times of the customer inputs.

7. The system of claim 1, wherein the signals comprise customer personal information, the personal information including at least one of name, age, gender, and address.

8. A method comprising:
providing a switch array in a service provider outlet, wherein the switch array includes two or more touch-sensitive areas that each correspond to a level of customer satisfaction;
generating and transmitting a signal at the switch array in response to a customer input, the signal including information of the level of customer satisfaction;
receiving the signal and storing the signal in a database; and
generating a report using information of the received signal, the report including cumulative customer satisfaction ratings for a time period.

9. The method of claim 8, wherein the switch array includes a first switch in a first location of the service provider outlet, wherein the first switch includes a first touch-sensitive area by which a customer indicates a first level of customer satisfaction and a second touch-sensitive area by which the customer indicates a second level of customer satisfaction.

10. The method of claim 8, wherein the switch array includes two or more switches each of which are located in different locations of the service provider outlet, wherein each switch includes a plurality of touch-sensitive areas by which a customer indicates a respective one of a plurality of levels of customer satisfaction.

11. The method of claim 8, wherein the transmitting and the receiving includes transferring the signal using at least one of wired, wireless, and hybrid wired/wireless communication systems.

12. The method of claim 8, wherein the database further includes at least one of information of employees, dates of the customer inputs, and times of the customer inputs.

13. The method of claim 8, wherein the report correlates the customer satisfaction ratings with at least one of employees on duty at a time of the customer input, dates of the customer inputs, and times of the customer inputs.

14. The method of claim 8, wherein the signal comprises customer personal information, the personal information including at least one of name, age, gender, and address.

15. An apparatus comprising:
means for receiving in a service provider outlet electronic input information of a level of customer satisfaction;
means for generating and transmitting a signal in response to the input information, the signal including information of the level of customer satisfaction;
means for receiving the signal and storing the signal; and
means for generating a report using information of the received signal, the report including cumulative customer satisfaction ratings for a time period.

16. The apparatus of claim 15, wherein the means for receiving electronic input information comprises a switch array that includes a first switch in a first location of the service provider outlet, wherein the first switch includes a first touch-sensitive area by which a customer indicates a first level of customer satisfaction and a second touch-sensitive area by which the customer indicates a second level of customer satisfaction.

17. The apparatus of claim 15, wherein the means for receiving electronic input information comprises a switch array that includes two or more switches each of which are located in different locations of the service provider outlet, wherein each switch includes a plurality of touch-sensitive areas by which a customer indicates a respective one of a plurality of levels of customer satisfaction.

18. The apparatus of claim 15, wherein the means for transmitting and the means for receiving the signal includes at least one of wired, wireless, and hybrid wired/wireless communication systems.

19. The apparatus of claim 15, wherein the means for storing further includes at least one of information of employees, dates of the customer inputs, and times of the customer inputs.

20. The apparatus of claim 15, wherein the means for generating a report further comprises means for correlating the customer satisfaction ratings with at least one of employees on duty at a time of the customer input, dates of the customer inputs, and times of the customer inputs.
